(19) United States
(12) Patent Application Publication
(10) Pub. No.: US 2023/0294635 A1
(43) Pub. Date: Sep. 21, 2023

(54) WIRELESS COMMUNICATION SYSTEM AND VEHICLE-MOUNTED DEVICE

(71) Applicant: Panasonic Intellectual Property Management Co., Ltd., Osaka (JP)

(72) Inventors: Genki SAITO, Kanagawa (JP); Masami TAKIGAWA, Kanagawa (JP); Hitoshi NAMBA, Kanagawa (JP); Jun FUJIYAMA, Kanagawa (JP)

(21) Appl. No.: 18/186,077

(22) Filed: Mar. 17, 2023

(30) Foreign Application Priority Data
Mar. 18, 2022 (JP) 2022-043894

(51) Int. Cl. B60R 25/01; B60R 25/24; G07C 9/00

(52) U.S. Cl. CPC B60R 25/01; B60R 25/24; G07C 9/00309

(57) ABSTRACT

In digital wireless communication performed between a vehicle and an electronic key terminal, the electronic key terminal and the vehicle periodically perform advertising transmission at a first time interval, periodically perform, at a second time interval, verification communication of confirming whether authentication of the electronic key terminal is established after the advertising transmission, periodically perform, at a third time interval, periodic communication performed after the authentication is established in the verification communication, and set the third time interval of the periodic communication to be longer than the second time interval of the verification communication. Accordingly, the responsiveness of the communication between the electronic key terminal and the vehicle can be improved. In addition, the first time interval of the advertising transmission is set to be longer than the second time interval of the verification communication. Accordingly, a reduction in power consumption of the vehicle 1 can be achieved.

### TECHNICAL FIELD

The present disclosure relates to a wireless communication system including an electronic key terminal and an in-vehicle device capable of digital wireless communication with the electronic key terminal, and relates to the in-vehicle device.

### BACKGROUND ART

In the related art, a short-range wireless communication device with which an electronic key terminal such as a high-performance mobile phone and a communication partner thereof communicate with each other through short-range wireless communication is known. For the short-range wireless communication, for example, Bluetooth (registered trademark) is used. As a standard of Bluetooth communication, for example, there is Bluetooth low energy (BLE) capable of suppressing power consumption. In accordance with BLE, data communication is performed at fixed intervals (connection intervals) between an electronic key terminal and a communication partner.

For example, Patent Literature 1 discloses a control device capable of improving responsiveness of communication between an electronic key terminal and an in-vehicle device that is a communication partner of the electronic key terminal.

### CITATION LIST

### Patent Literature

Patent Literature 1: Japanese Patent No. 6616159

### SUMMARY OF INVENTION

However, in the control device disclosed in Patent Literature 1, although the responsiveness of the communication can be improved by making a time interval for transmitting a request signal (a signal for requesting a response from the electronic key terminal) from a communication module of the in-vehicle device in verification communication to be shorter than a time interval for transmitting a request from the communication module of the in-vehicle device in periodic communication, power consumption of the in-vehicle device is increased since a communication frequency of the verification communication is increased. As a result, durability of a battery is deteriorated. The verification communication is, for example, communication performed at the time of authenticating the electronic key terminal, that is, communication performed when a locked vehicle is to be unlocked using the electronic key terminal, and accordingly a power source is only the battery.

An object of the present disclosure is to provide a wireless communication system and an in-vehicle device capable of reducing power consumption of the in-vehicle device while improving responsiveness in communication between an electronic key terminal and the in-vehicle device capable of digital wireless communication with the electronic key terminal.

A wireless communication system of the present disclosure includes an electronic key terminal, and an in-vehicle device configured to be mounted on a vehicle and being capable of digital wireless communication with the electronic key terminal. At least one of the electronic key terminal and the in-vehicle device periodically performs advertising transmission at a first time interval. The electronic key terminal and the in-vehicle device periodically perform, at a second time interval, verification communication of confirming whether or not authentication of the electronic key terminal is established after the advertising transmission, and periodically perform, at a third time interval, periodic communication performed after the authentication is established in the verification communication. At least a part of the periodic communication includes a command for changing a state of the vehicle, the third time interval of the periodic communication is longer than the second time interval of the verification communication, and the first time interval of the advertising transmission is longer than the second time interval of the verification communication.

According to the present disclosure, the in-vehicle device makes the third time interval of the periodic communication to be longer than the second time interval of the verification communication in the digital wireless communication with the electronic key terminal. Accordingly, in the verification communication performed after the establishment of the digital wireless communication performed between the in-vehicle device and the electronic key terminal, communication according to processing in which the electronic key terminal returns a response in response to calling from the in-vehicle device can be immediately completed, and responsiveness of the communication can be improved.

In addition, since the first time interval of the advertising transmission is set to be longer than the second time interval of the verification communication after the advertising transmission, a frequency of the advertising transmission is lower than a frequency of the verification communication, and a reduction in power consumption of the in-vehicle device can be achieved.

In the wireless communication system of the present disclosure, the first time interval of the advertising transmission is longer than the third time interval of the periodic communication.

According to the present disclosure, since the first time interval of the advertising transmission is set to be longer than the third time interval of the periodic communication after the verification communication, the frequency of the advertising transmission is lower than a frequency of the periodic communication, and a reduction in power consumption of the in-vehicle device can be achieved.

In the wireless communication system of the present disclosure, the advertising transmission is performed by the in-vehicle device.

According to the present disclosure, a reduction in power consumption of the in-vehicle device can be achieved.

In the wireless communication system of the present disclosure, the advertising transmission is broadcast communication.

According to the present disclosure, it is possible to perform the advertising transmission to all electronic key terminals existing near a vehicle.

In the wireless communication system of the present disclosure, the verification communication and the periodic communication are unicast communication, respectively.

According to the present disclosure, it is possible to perform the verification communication and the periodic communication with one electronic key terminal existing near the vehicle.

In the wireless communication system of the present disclosure, the digital wireless communication conforms to a Bluetooth (registered trademark) standard.

According to the present disclosure, it is possible to perform the communication conforming to the Bluetooth standard between the electronic key terminal and the in-vehicle device.

In the wireless communication system of the present disclosure, the verification communication includes ID verification of the electronic key terminal and challenge response authentication.

According to the present disclosure, a more correct determination of validity of the electronic key terminal is facilitated.

In the wireless communication system of the present disclosure, the periodic communication includes at least a request signal, and the request signal is a message request for requesting return of an outgoing message.

According to the present disclosure, the in-vehicle device can request an instruction (for example, a command necessary for operating the vehicle) related to remote control performed by the electronic key terminal from the electronic key terminal.

In the wireless communication system of the present disclosure, the periodic communication at least includes command communication of transmitting a command necessary for operating the vehicle from the electronic key terminal to the in-vehicle device, and operating-state communication of notifying the electronic key terminal of operating-state information related to a current operating state of the vehicle.

According to the present disclosure, a command can be transmitted from the electronic key terminal to the in-vehicle device through the command communication performed in the periodic communication. Further, it is also possible to notify the electronic key terminal of a current operating state of the in-vehicle device through the operating-state communication performed in the periodic communication.

In the wireless communication system of the present disclosure, at least a part of the periodic communication is encrypted.

According to the present disclosure, it is possible to safely transmit an outgoing message to a partner side through encrypted communication.

An in-vehicle device of the present disclosure is configured to be mounted on a vehicle and is capable of digital wireless communication with an external electronic key terminal. At least one of the electronic key terminal and the in-vehicle device periodically performs advertising transmission at a first time interval. The electronic key terminal and the in-vehicle device periodically perform, at a second time interval, verification communication of confirming whether authentication of the electronic key terminal is established after the advertising transmission, and periodically perform, at a third time interval, periodic communication performed after the authentication is established in the verification communication. At least a part of the periodic communication includes a command for changing a state of the vehicle, the third time interval of the periodic communication is longer than the second time interval of the verification communication, and the first time interval of the advertising transmission is longer than the second time interval of the verification communication.

According to the present disclosure, the in-vehicle device makes the third time interval of the periodic communication to be longer than the second time interval of the verification communication in the digital wireless communication with the electronic key terminal. Accordingly, in the verification communication performed after the establishment of the digital wireless communication performed between the in-vehicle device and the electronic key terminal, communication according to processing in which the electronic key terminal returns a response in response to calling from the in-vehicle device can be immediately completed, and responsiveness of the communication can be improved.

In addition, since the first time interval of the advertising transmission is set to be longer than the second time interval of the verification communication after the advertising transmission, a frequency of the advertising transmission is lower than a frequency of the verification communication, and a reduction in power consumption of the in-vehicle device can be achieved.

In the in-vehicle device of the present disclosure, the first time interval of the advertising transmission is longer than the third time interval of the periodic communication.

According to the present disclosure, since the first time interval of the advertising transmission is set to be longer than the third time interval of the periodic communication after the verification communication, the frequency of the advertising transmission is lower than a frequency of the periodic communication, and a reduction in power consumption of the in-vehicle device can be achieved.

In the in-vehicle device of the present disclosure, the advertising transmission is performed by the in-vehicle device.

According to the present disclosure, a reduction in power consumption of the in-vehicle device can be achieved.

In the in-vehicle device of the present disclosure, the advertising transmission is broadcast communication.

According to the present disclosure, it is possible to perform the advertising transmission to all electronic key terminals existing near a vehicle.

In the in-vehicle device of the present disclosure, the verification communication and the periodic communication are unicast communication, respectively.

According to the present disclosure, it is possible to perform the verification communication and the periodic communication with one electronic key terminal existing near the vehicle.

In the in-vehicle device of the present disclosure, the digital wireless communication conforms to a Bluetooth (registered trademark) standard.

According to the present disclosure, it is possible to perform the communication conforming to the Bluetooth standard between the electronic key terminal and the in-vehicle device.

In the in-vehicle device of the present disclosure, the verification communication includes ID verification of the electronic key terminal and challenge response authentication.

According to the present disclosure, a more correct determination of validity of the electronic key terminal is facilitated.

In the in-vehicle device of the present disclosure, the periodic communication includes at least a request signal, and the request signal is a message request for requesting return of an outgoing message.

According to the present disclosure, the in-vehicle device can request an instruction (for example, a command necessary for operating the vehicle) related to remote control performed by the electronic key terminal from the electronic key terminal.

In the in-vehicle device of the present disclosure, the periodic communication at least includes command communication of transmitting a command necessary for operating the vehicle from the electronic key terminal to the in-vehicle device, and operating-state communication of notifying the electronic key terminal of operating-state information related to a current operating state of the vehicle.

According to the present disclosure, a command can be transmitted from the electronic key terminal to the in-vehicle device through the command communication performed in the periodic communication. Further, it is also possible to notify the electronic key terminal of a current operating state of the in-vehicle device through the operating-state communication performed in the periodic communication.

In the in-vehicle device of the present disclosure, at least a part of the periodic communication is encrypted.

According to the present disclosure, it is possible to safely transmit an outgoing message to a partner side through encrypted communication.

According to the present disclosure, it is possible to reduce power consumption of an in-vehicle device while improving responsiveness in communication between an electronic key terminal and the in-vehicle device capable of digital wireless communication with the electronic key terminal.

### BRIEF DESCRIPTION OF DRAWINGS

FIG. 1 is a configuration diagram of a wireless communication system according to an embodiment;

FIG. 2 is a communication sequence diagram of the wireless communication system;

FIG. 3 is a detailed communication sequence diagram of the wireless communication system, and

FIG. 4A is a detailed communication sequence diagram of the wireless communication system, and FIG. 4B is another detailed communication sequence diagram of the wireless communication system.

### DESCRIPTION OF EMBODIMENTS

Hereinafter, an embodiment (hereinafter, referred to as “the embodiment”) in which a wireless communication system according to the present disclosure is specifically disclosed will be described in detail with reference to the drawings as appropriate. However, unnecessarily detailed description may be omitted. For example, a detailed description of well-known matters and a redundant description of substantially the same configuration may be omitted. This is to avoid the following description from being unnecessarily redundant and facilitate understanding by those skilled in the art. The accompanying drawings and the following description are provided for those skilled in the art to fully understand the present disclosure and are not intended to limit the subject matters described in the claims.

Hereinafter, preferred embodiments for carrying out the present disclosure will be described in detail with reference to the drawings.

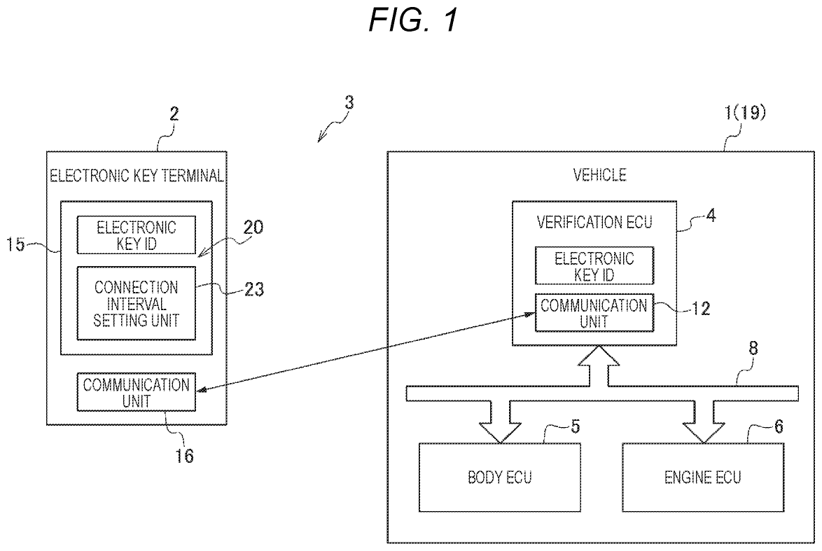

A wireless communication system according to the embodiment will be described with reference to FIGS. 1 to 4A and 4B.

As illustrated in FIG. 1, a vehicle 1 includes a wireless communication system 3 that wirelessly performs ID verification with an electronic key terminal 2. The wireless communication system 3 performs ID verification by wireless communication in response to communication from the vehicle 1, for example. In the wireless communication system 3 of the example, Bluetooth (registered trademark) is used for communication. Further, Bluetooth low energy (BLE) is used in Bluetooth communication of the example.

The vehicle 1 includes a verification electronic control unit (ECU) 4 that performs ID verification, a body ECU 5 that manages a power supply of an onboard electrical component, and an engine ECU 6 that controls an engine (not shown). The verification ECU 4 corresponds to an in-vehicle device. The verification ECU 4, the body ECU 5, and the engine ECU 6 are connected to each other through a communication line 8 in the vehicle. Examples of the communication line 8 include a controller area network (CAN) and a local interconnect network (LIN). In the verification ECU 4, an electronic key ID of the electronic key terminal 2 registered in the vehicle 1 is written and stored in a memory (not shown). The body ECU 5 controls an operation of a door locking mechanism (not shown) that switches between locking and unlocking of a vehicle door.

The vehicle 1 includes a communication unit 12 that enables wireless communication (Bluetooth communication) with the electronic key terminal 2 in the vehicle 1, The communication unit 12 is connected to the verification ECU 4, and an operation thereof is managed by the verification ECU 4. The communication unit 12 confirms whether the electronic key terminal 2 responds to a call from the communication unit 12, thereby monitoring whether the Bluetooth communication is established.

The electronic key terminal 2 includes a key control unit 15 that controls an operation of the electronic key terminal 2, and a communication unit 16 that enables the electronic key terminal 2 to perform wireless communication (Bluetooth communication) with the vehicle 1, In the key control unit 15, an electronic key ID that is a unique ID of the electronic key terminal 2 is written and stored in a memory (not shown). The communication unit 16 is connected to the key control unit 15, and an operation thereof is managed by the key control unit 15. The communication unit 16 notifies the vehicle 1 of presence of the communication unit 16 by returning a response to a call from the vehicle 1, The electronic key terminal 2 may be, for example, a high-performance mobile phone having a key function other than a dedicated terminal having only a key function.

The wireless communication system 3 has a function (a short-range wireless communication device 20) of appropriately switching a connection interval T, which is an interval of repetition of calling, in wireless communication performed between a communication partner 19 (the vehicle 1 in the example) of the electronic key terminal 2 and the electronic key terminal 2. In communication connection in which one party responds to a call from another party, the short-range wireless communication device 20 of the example switches a connection interval T that is a communication call interval of the communication connection, thereby implementing BLE control that has improved responsiveness and lower power consumption.

The short-range wireless communication device 20 includes a connection interval setting unit 23 capable of setting the connection interval T for short-range wireless communication (in the example, Bluetooth communication). The connection interval setting unit 23 is provided in the key control unit 15 of the electronic key terminal 2. In verification communication of confirming validity of the electronic key terminal 2 after the establishment of the short-range wireless communication, the connection interval setting unit 23 of the example operates to set the connection interval T, which is an interval of repetition of communication call, to be short. After the verification communication, the connection interval setting unit 23 sets the connection interval 1 to be long. In addition, the connection interval setting unit 23 of the example operates to set a connection interval of advertising transmission to be longer than the connection interval of the verification communication after the advertising transmission.

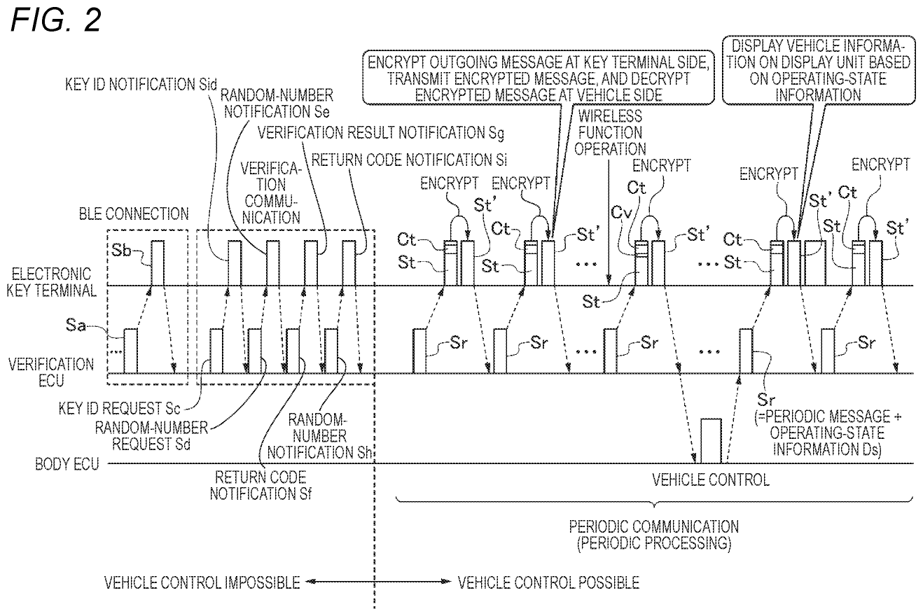

Next, an operation of the short-range wireless communication device 20 will be described with reference to FIGS. 2 to 4A and 4B.

As illustrated in FIG. 2, in order to confirm whether the electronic key terminal 2 with which communication is established exists in the vicinity, the verification ECU 4 periodically and repeatedly transmits, from the communication unit 12, a connection confirmation radio wave Sa for confirming (short-range wireless) link establishment of the Bluetooth communication. When the electronic key terminal 2 enters an area of Bluetooth communication and receives the connection confirmation radio wave Sa, the electronic key terminal 2 returns a response radio wave Sb to the vehicle 1 through the Bluetooth communication. When the verification ECU 4 can receive the response radio wave Sb within a certain period of time after the transmission of the connection confirmation radio wave Sa, the verification ECU 4 recognizes that Bluetooth connection is completed. That is, it is determined that the Bluetooth communication is established.

After confirming that the Bluetooth communication is established, the verification ECU 4 starts processing of verification communication. The verification communication processing is communication for confirming validity of the electronic key terminal 2 for which the link of the Bluetooth communication is established, and is performed only once at the time of the Bluetooth communication connection. During the verification communication, for ID verification of the electronic key terminal 2, the verification ECU 4 first transmits a key ID request Sc to the electronic key terminal 2 for causing the electronic key terminal 2 to transmit an electronic key ID thereof. When the electronic key terminal 2 receives the key ID request Sc from the verification ECU 4, the electronic key terminal 2 transmits a key ID notification Sid including the electronic key ID registered therein to the verification ECU 4. When receiving the key ID notification Sid from the electronic key terminal 2, the verification ECU 4 confirms the electronic key ID included in the key ID notification Sid to authenticate the electronic key ID.

When it is confirmed that the authentication of the electronic key ID is established, the verification ECU 4 subsequently performs challenge response authentication. The challenge response authentication of the example is performed in both the vehicle 1 and the electronic key terminal 2. At this time, the verification ECU 4 transmits, to the electronic key terminal 2, a random-number request Sd for causing the electronic key terminal 2 to return a random-number whose value changes every time the return is performed. When receiving the random-number request Sd from the vehicle 1, the electronic key terminal 2 transmits a random-number notification Se including a random number to be calculated at this time to the vehicle 1. The verification ECU 4 generates a return code by passing the random number received from the electronic key terminal 2 through an encryption key registered in the verification ECU 4, and transmits the return code as a return code notification Sf to the electronic key terminal 2. The electronic key terminal 2 also calculates a return code by passing the random number through an encryption key of the electronic key terminal 2. When receiving the return code notification Sf from the vehicle 1, the electronic key terminal 2 confirms validity of the return code based on the return code notification Sf. The electronic key terminal 2 transmits a verification result notification Sg, which is an authentication result of the return code, to the vehicle 1.

When it is confirmed, in the verification result notification Su received from the electronic key terminal 2, that the verification of the return code in the electronic key terminal 2 is established, the verification ECU 4 transmits a random-number notification Sh including a random number generated by the verification ECU 4 to the electronic key terminal 2. The electronic key terminal 2 generates a return code by passing the random number received from the verification ECU 4 through the encryption key registered in the electronic key terminal 2, and transmits the return code as a return code notification Si to the verification ECU 4. The verification ECU 4 also calculates a return code by passing the random number through the encryption key of the verification ECU 4. When receiving the return code notification Si from the electronic key terminal 2, the verification ECU 4 confirms validity of the return code based on the return code notification Si. When it is confirmed that the series of verification and authentication are established, the verification ECU 4 recognizes that the ID verification is established.

When it is confirmed that the ID verification with the electronic key terminal 2 is established in the verification communication, the verification ECU 4 executes processing of periodic communication that is periodically performed between the vehicle 1 and the electronic key terminal 2. The periodic communication is packet communication. The periodic communication processing includes command communication processing (command communication) of transmitting an instruction (command) for remote control from the electronic key terminal 2 to the vehicle 1, and operating-state notification processing (operating-state communication) of notifying the electronic key terminal 2 of a current operating state of the communication partner 19 (the vehicle 1 in the example). In the periodic communication processing, the verification ECU 4 first performs the command communication processing. At this time, the verification ECU 4 transmits, to the electronic key terminal 2, a message request Sr (request signal) serving as a trigger for causing the electronic key terminal 2 to return a command. The message request Sr is a message request for requesting the electronic key terminal 2 to transmit an outgoing message. The message request Sr may include a periodic message to be notified to the electronic key terminal 2 each time.

When receiving the message request Sr from the vehicle 1, the electronic key terminal 2 transmits an outgoing message St to the vehicle 1 as an instruction related to the remote control performed by the electronic key terminal 2. The outgoing message includes a command Ct that is instruction information from the electronic key terminal 2 to the vehicle 1. At this time, the electronic key terminal 2 encrypts the outgoing message St and transmits an encrypted outgoing message St′ to the vehicle 1. The encryption key used to encrypt the outgoing message St may be the same key as that used in the challenge response authentication or may be a different key. Here, it is assumed that the remote control is not performed by the electronic key terminal 2, and the outgoing message St includes a command Ct that does not particularly instruct an operation of the vehicle 1. All or a part of the information transmitted in the periodic communication may be encrypted.

When receiving the encrypted outgoing message St′ from the electronic key terminal 2, the verification ECU 4 decrypts the outgoing message St′ with the encryption key of the verification ECU 4. Then, the verification ECU 4 executes vehicle control based on the command Ct included in the outgoing message St. Since the command Ct at this time transmits a request that does not instruct an operation of the vehicle 1, the verification ECU 4 does not particularly perform vehicle control and maintains a current state. The processing of transmitting the message request Sr from the vehicle 1 to the electronic key terminal 2 and causing the electronic key terminal 2 to return the outgoing message St is periodically repeated.

Here, it is assumed that remote control (wireless function operation) of the communication partner 19 (the vehicle 1 in the example) is executed by the electronic key terminal 2. At this time, in transmitting the outgoing message St to the vehicle 1, the electronic key terminal 2 transmits the outgoing message St including operation request information Cv corresponding to the remote control to the vehicle 1. It is preferable that the operation request information Cv is, for example, information in which a request flag is set to “ON”. Here, for example, it is assumed that a wireless door locking operation (remote door locking operation) is performed by the electronic key terminal 2, and the operation request information Cv indicating the operation is notified to the vehicle 1. When receiving the outgoing message St including the operation request information Cv, the verification ECU 4 sets the operation request information Cv as a trigger and controls a piece of equipment mounted on the vehicle 1. For example, when the operation request information Cv for the wireless door locking operation is included in the outgoing message St, a vehicle door is locked by the body ECU 5.

In transmitting the message request Sr to the electronic key terminal 2 after controlling the equipment mounted on the vehicle 1, the verification ECU 4 transmits operating-state information Ds related to the controlled operation to the electronic key terminal 2 in addition to the periodic message. When the message request Sr including the periodic message and the operating-state information Ds is received, the electronic key terminal 2 returns the outgoing message St (encrypted outgoing message St′) to the vehicle 1 in the same mode as before. At this time, since the operating-state information Ds is included in the message request Sr, the electronic key terminal 2 displays the current state of the vehicle 1 on a display unit (not shown) of the electronic key terminal 2 based on the operating-state information Ds. For example, when a vehicle door is unlocked, the electronic key terminal 2 displays on a screen of a display unit (not shown) that a vehicle door is unlocked.

The processing of transmitting the message request Sr from the vehicle 1 to the electronic key terminal 2 and causing the electronic key terminal 2 to return the outgoing message St is continued until the link of the Bluetooth communication is no longer established. That is, the periodic communication between the vehicle 1 and the electronic key terminal 2 is continued until the Bluetooth communication is cut off.

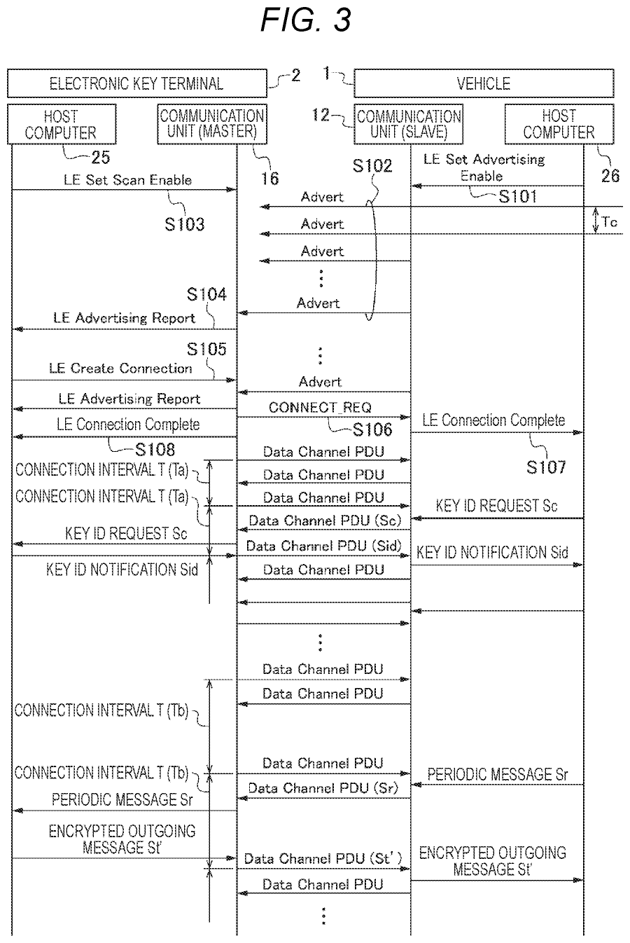

Next, FIG. 3 illustrates a specific setting example of the connection interval T. As illustrated in FIG. 3, the electronic key terminal 2 includes a host computer 25 that controls an operation of the communication unit 16 provided in the electronic key terminal 2. The host computer 25 is a type of application for controlling the Bluetooth communication, and is preferably provided in the key control unit 15, for example. The vehicle 1 includes a host computer 26 that controls an operation of the communication unit 12 provided in the vehicle 1, The host computer 26 is a type of application for controlling the Bluetooth communication, and is preferably provided in the verification ECU 4 of the vehicle 1, for example.

First, in step 101, the host computer 26 causes the communication unit 12 to start advertising according to an LE Set Advertising Enable command. The advertising is a type of operation of notifying presence of the vehicle 1 to the surroundings.

In step 102, when entering an advertising state, the communication unit 12 periodically transmits an advertising packet “Advert” to the surroundings. It is preferable to use broadcast communication for the advertising transmission. By using the broadcast communication, it is possible to perform the advertising transmission to all the electronic key terminals existing near the vehicle 1.

On the other hand, in step 103, the host computer 25 causes the communication unit 16 to start scanning according to an LE Set Scan Enable command. The scanning is a type of operation for finding a device existing in the surroundings.

In step 104, when the electronic key terminal 2 enters a communication area of the communication unit 12 (an area of the Bluetooth communication), if the advertising packet is received in the scanning state by the communication unit 16, the communication unit 16 generates an LE Advertising Report event and notifies the host computer 25 of a scan result.

In step 105, the host computer 25 causes the communication unit 16 to start connection of the Bluetooth communication according to an LE Create Connection command.

In step 106, when the communication unit 16 receives the advertising packet from the vehicle 1 in a state in which the connection of the Bluetooth communication is started, the communication unit 16 transmits a CONNECT REQ necessary for establishing the Bluetooth communication to the vehicle 1.

In step 107, when receiving the CONNECT REQ from the electronic key terminal 2, the communication unit 12 outputs LE Connection Complete to the host computer 26 to notify the host computer 26, which has a higher rank, of the completion of the connection of the Bluetooth communication. When LE Connection Complete is received, the host computer 26 starts the processing of verification communication. The verification communication between the electronic key terminal 2 and the vehicle 1 is preferably unicast communication. By using the unicast communication, it is possible to perform the verification communication and the periodic communication with one electronic key terminal 2 existing near the vehicle.

In step 108, the communication unit 16 outputs LE Connection Complete to the host computer 25 after the transmission of CONNECT REQ, thereby notifying the host computer 25, which has a higher rank, of the completion of the connection of the Bluetooth communication. In this way, the connection (link establishment) of the Bluetooth communication is completed. After the communication link is established, communication is performed while repeating connection communication in which the communication unit 12 responds to calling from the communication unit 16.

After the communication link is established, the host computer 25 starts the processing of verification communication when LE Connection Complete is received. At this time, the connection interval setting unit 23 preferably sets the connection interval T in the verification communication to “Ta” that is a shorter time interval (second time interval), and sets the connection interval T in the periodic communication to “Tb (>Ta)” that is a longer time interval (third time interval).

In the verification communication, the communication unit 16 repeatedly transmits a Data. Channel protocol data unit (PDU), which is one unit of data communication, at an interval of the connection interval Ta. The connection interval Ta is set to a short interval such that a response from the vehicle 1 can be immediately received. The Data Channel PDU transmitted from the electronic key terminal 2 at this time is “Empty” in which no data is included.

The communication unit 12 performs an operation of returning various signals to the electronic key terminal 2 in response to the Data Channel PDU from the electronic key terminal 2 under the execution of the verification communication, and returns necessary data to the electronic key terminal 2 at a timing of next periodic transmission subsequent to reception of various transmission requests from the host computer 26. In the case of the example, since a signal to be transmitted first in the verification communication is the key ID request Sc, the communication unit 12 transmits the key ID request Sc to the electronic key terminal 2 at a return timing of the Data Channel PDU subsequent to the reception of the key ID request Sc from the host computer 26.

When receiving the key ID request Sc from the vehicle 1, the communication unit 16 outputs the key ID request Sc to the host computer 25. Then, the host computer 25 causes the communication unit 16 to transmit the key ID notification Sid in response to the key ID request Sc. As described above, the above-described processing of verification communication is performed.

When the verification communication ends, the periodic communication is subsequently performed. At this time, the communication unit 16 repeatedly transmits the Data Channel PDU at intervals of the connection interval Tb. The connection interval Tb in the example is set to a time interval longer than Ta described above. Then, in the periodic communication, the message request Sr and the encrypted outgoing message St′ are received at a timing of a long interval “Tb” that is the connection interval T of the Data Channel PDU. For the periodic communication between the electronic key terminal 2 and the vehicle 1, unicast communication is preferable.

By setting the connection interval (third time interval) Tb of the periodic communication to be longer than the connection interval (second time interval) Ta of the verification communication, it is possible to immediately complete the communication in accordance with processing in which one of the vehicle 1 and the electronic key terminal 2 returns a response in response to calling from the other in the verification communication. That is, the responsiveness of communication can be improved.

In addition, by setting a connection interval (first time interval) Tc of the advertising transmission to be longer than the connection interval (second time interval) Ta of the verification communication, a reduction in power consumption of the verification ECU 4 of the vehicle 1 can be achieved, That is, since a frequency of advertising transmission is reduced by setting the connection interval of the advertising transmission to be long, power consumption is reduced consequently.

Further, the connection interval (first time interval) Tc of the advertising transmission may be set to be longer than the connection interval (third time interval) Tb of the periodic communication or may be set to be shorter than the connection interval Tb of the periodic communication. However, in either case, the connection interval Tc of the advertising transmission is set to be longer than the connection interval Ta of the verification communication.

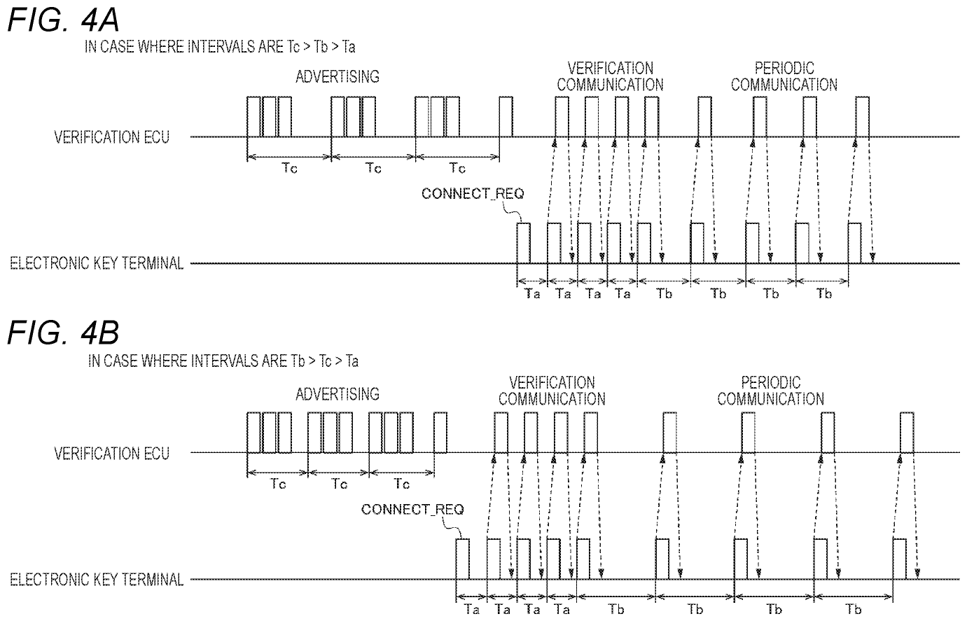

Here, FIG. 4A illustrates a communication sequence in a case where the connection intervals are Tc>Tb>Ta, and FIG. 4B illustrates a communication sequence in a case where the connection intervals are Tb>Tc>Ta. FIG. 4A illustrates the case of Tc>Tb>Ta, and the first time interval Tc is set to be longer than the third time interval Tb. FIG. 4B illustrates the case of Tb Tc>Ta, and the first time interval Tc is set to be shorter than the third time interval Tb but longer than the second time interval Ta.

According to the configuration of the embodiment, the following effects can be obtained. (1) In the digital wireless communication (Bluetooth communication) performed between the vehicle 1 and the electronic key terminal 2, the electronic key terminal 2 and the vehicle 1 periodically perform the advertising transmission at the first time interval, periodically perform, at the second time interval, the verification communication of confirming whether authentication of the electronic key terminal 2 is established after the advertising transmission, periodically perform, at the third time interval, the periodic communication performed after the authentication is established in the verification communication, and set the third time interval of the periodic communication to be longer than the second time interval of the verification communication. Accordingly, in the verification communication performed after the establishment of the digital wireless communication performed between the vehicle 1 and the electronic key terminal 2, communication according to processing in which the electronic key terminal 2 returns a response in response to calling from the vehicle 1 can be immediately completed, and responsiveness of the communication can be improved.
(2) in addition, the first time interval of the advertising transmission is set to be longer than the second time interval of the verification communication. Accordingly, it is possible to reduce a frequency of the advertising transmission to be lower than a frequency of the verification communication, and a reduction in power consumption of the vehicle 1 can be achieved. As a matter of course, it is possible to set the first time interval of the advertising transmission to be longer than the third time interval of the periodic communication, and in this case, a reduction in power consumption of the verification ECU 4, that is, a reduction in power consumption of the vehicle 1 can be achieved.
(3) In addition, since a vehicle side performs the advertising transmission, a reduction in power consumption of the vehicle 1 can be achieved.
(4) In addition, since the broadcast communication is used for the advertising transmission, it is possible to perform the advertising transmission to all the electronic key terminals 2 existing near the vehicle 1,
(5) In addition, since the unicast communication is used for both the verification communication and the periodic communication, the verification communication and the periodic communication can be performed with one electronic key terminal 2 existing near the vehicle 1.
(6) In addition, since the digital wireless communication conforms to the Bluetooth (registered trademark) standard, the electronic key terminal 2 and the vehicle 1 can communicate with each other according to the Bluetooth standard.
(7) In addition, since the ID verification of the electronic key terminal 2 and the challenge response authentication are included in the verification communication, a more correct determination of validity of the electronic key terminal 2 is facilitated.
(8) In addition, since the periodic communication includes at least a request signal and the request signal is set as a message request for requesting return of the outgoing message, the vehicle side can request an instruction (for example, a command necessary for operating the vehicle) related to the remote control performed by the electronic key terminal 2 from the electronic key terminal 2.
(9) In addition, since the periodic communication includes at least the command communication of transmitting a command necessary for operating the vehicle from the electronic key terminal 2 to the vehicle 1 and the operating-state communication of notifying the electronic key terminal 2 of the operating-state information related to the current operating state of the vehicle 1, it is possible to transmit the command from the electronic key terminal 2 to the vehicle 1 through the command communication performed in the periodic communication. It is also possible to notify the electronic key terminal 2 of the current operating state of the vehicle through the operating-state communication performed in the periodic communication.
(10) In addition, since at least a part of the periodic communication is encrypted, it is possible to safely transmit the outgoing message to a partner side.

The embodiment is not limited to the configurations described above, and may be modified to the following aspects.

The connection intervals Ta and Tb are not limited to fixed values and may be variable. For example, when the connection interval Tb is variable, the connection interval Tb may be gradually increased as execution time of the communication increases.

When the connection interval T is variable, the connection interval T may be changed according to the type of the electronic key terminal 2 and the communication format.

The verification communication can be appropriately changed to various modes as long as it is possible to confirm (authenticate) the validity of the electronic key terminal 2.

The communication performed after the verification communication is not limited to the periodic communication, and may be any type of communication as long as the communication is performed between the electronic key terminal 2 and the communication partner 19.

The verification communication is not limited to being performed only once, and may be performed, for example, a plurality of times by being periodically repeated.

The outgoing message St may be transmitted to the partner without being encrypted.

The outgoing message St may be constructed from any type of information.

The vehicle control notified to the electronic key terminal 2 is not limited to door locking control, and may be appropriately changed to other type of information as long as the information is operation information of a piece of equipment provided in the communication partner 19.

When the side from which the Data Channel PDU is sent is the vehicle 1 side, the connection interval setting unit may be provided in the vehicle 1.

The electronic key terminal 2 is not limited to a high-performance mobile phone, and can be changed to various terminals.

The equipment that is controlled through the Bluetooth communication is not limited to a door lock (door locking mechanism) of a vehicle door, and may be changed.

The communication sequence of the short-range wireless communication is not limited to the example illustrated in FIG. 3, and can be changed to another format.

The connection interval Ta may be a repetition transmission interval of radio waves in the verification communication. The connection interval Tb may be a repetition transmission interval of radio waves in the communication performed after the verification communication.

The short-range wireless communication device 20 is applicable not only to the vehicle 1 but also to other pieces of equipment and devices.

### INDUSTRIAL APPLICABILITY

The wireless communication system and the in-vehicle device of the present disclosure are useful for vehicles such as a four-wheeled vehicle and a two-wheeled vehicle.

What is claimed is:

1. A wireless communication system comprising:
an electronic key terminal; and
an in-vehicle device configured to be mounted on a vehicle and being capable of digital wireless communication with the electronic key terminal, wherein
at least one of the electronic key terminal and the in-vehicle device periodically performs advertising transmission at a first time interval,
the electronic key terminal and the in-vehicle device
periodically perform, at a second time interval, verification communication of confirming whether or not authentication of the electronic key terminal is established after the advertising transmission, and
periodically perform, at a third time interval, periodic communication performed after the authentication is established in the verification communication,
at least a part of the periodic communication includes a command for changing a state of the vehicle,
the third time interval of the periodic communication is longer than the second time interval of the verification communication, and
the first time interval of the advertising transmission is longer than the second time interval of the verification communication.

2. The wireless communication system according to claim 1, wherein
the first time interval of the advertising transmission is longer than the third time interval of the periodic communication.

3. The wireless communication system according to claim 1, wherein
the advertising transmission is performed by the in-vehicle device.

4. The wireless communication system according to claim 1, wherein
the advertising transmission is broadcast communication.

5. The wireless communication system according to claim 4, wherein
the verification communication and the periodic communication are unicast communication, respectively.

6. The wireless communication system according to claim 1, wherein
the digital wireless communication conforms to a Bluetooth (registered trademark) standard.

7. The wireless communication system according to claim 1, wherein
the verification communication includes ID verification of the electronic key terminal and challenge response authentication.

8. The wireless communication system according to claim 1, wherein
the periodic communication includes at least a request signal, and
the request signal is a message request for requesting return of an outgoing message.

9. The wireless communication system according to claim 8, wherein
the periodic communication at least includes
command communication of transmitting a command necessary for operating the vehicle from the electronic key terminal to the in-vehicle device, and
operating-state communication of notifying the electronic key terminal of operating-state information related to a current operating state of the vehicle.

10. The wireless communication system according to claim 1, wherein
at least a part of the periodic communication is encrypted.

11. An in-vehicle device that is configured to be mounted on a vehicle and is capable of digital wireless communication with an external electronic key terminal, wherein
at least one of the electronic key terminal and the in-vehicle device periodically performs advertising transmission at a first time interval,
the electronic key terminal and the in-vehicle device
periodically perform, at a second time interval, verification communication of confirming whether authentication of the electronic key terminal s established after the advertising transmission, and
periodically perform, at a third time interval, periodic communication performed after the authentication is established in the verification communication,
at least a part of the periodic communication includes a command for changing a state of the vehicle,
the third time interval of the periodic communication is longer than the second time interval of the verification communication, and
the first time interval of the advertising transmission is longer than the second time interval of the verification communication.

12. The in-vehicle device according to claim 11, wherein
the first time interval of the advertising transmission is longer than the third time interval of the periodic communication.

13. The in-vehicle device according to claim 11, wherein
the advertising transmission is performed by the in-vehicle device.

14. The in-vehicle device according to claim 11, wherein
the advertising transmission is broadcast communication.

15. The in-vehicle device according to claim 14, wherein
the verification communication and the periodic communication are unicast communication, respectively.

16. The in-vehicle device according to claim 11, wherein
the digital wireless communication conforms to a Bluetooth (registered trademark) standard.

17. The in-vehicle device according to claim 11, wherein
the verification communication includes ID verification of the electronic key terminal and challenge response authentication.

18. The in-vehicle device according to claim 11, wherein
the periodic communication includes at least a request signal, and
the request signal is a message request for requesting return of an outgoing message.

19. The in-vehicle device according to claim 18, wherein
the periodic communication at least includes
command communication of transmitting a command necessary for operating the vehicle from the electronic key terminal to the in-vehicle device, and
operating-state communication of notifying the electronic key terminal of operating-state information related to a current operating state of the vehicle.

20. The in-vehicle device according to claim 11, wherein
at least a part of the periodic communication is encrypted.
